(19) United States
(12) Patent Application Publication
(10) Pub. No.: US 2007/0112634 A1
(43) Pub. Date: May 17, 2007

(54) System and method for confirming customer transactions

(75) Inventor: John D. Somers, Richmond, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: CAPITAL ONE FINANCIAL CORPORATION

(21) Appl. No.: 11/259,568

(22) Filed: Oct. 25, 2005

(51) Int. Cl. G06Q 30/00

(52) U.S. Cl. 705/26

(57) ABSTRACT

Systems and methods are provided for collecting sales confirmation data from customers contemporaneously with transactions between the customers and sales associates. The sales confirmation data is compared to sales data received from the sales associate to determine whether and which transactions are attributable to the sales associates. The sales confirmation data may be received by a voice recognition unit and may be received over a communication link established by the sales associates. The communication link may be a conferencing link that includes a customer, a sales associate and a receiver of the sales confirmation data. The communication link may be established by way of speed dial during the transaction between the customer and the sales associate.

### TECHNICAL FIELD OF THE INVENTION

This invention relates in general to customer transactions and, more particularly, to systems and methods for confirming whether a sales associate should be credited with a sale to a customer.

### BACKGROUND

In many industries, sales of goods or services are made to customers by sales associates. In certain industries, sales associates may work in call centers and conduct sales transactions over telephone communication systems. Sometimes, the sales associates working in the call centers receive compensation based on the number of successful sales they make. In such cases, some or all of the compensation may include sales commissions. In order for a sales associate to be given credit (and therefore a commission) for a sale, the sale must be confirmed. Typically, the confirmation simply includes manual tracking of sales. This manual tracking is typically performed by the sales associate that is making the sales. In some cases, in order to prevent fraudulent, or otherwise inaccurate reporting of sales, calls are recorded. The recordings (e.g., on tape) are later reviewed to verify that a particular sales associate made a particular sale.

### SUMMARY

In accordance with certain embodiments of the present invention, systems and methods are provided for confirming whether a transaction involving a customer is attributable to a sales associate. According to one embodiment, a system for confirming customer transactions includes at least one processor and at least one memory electronically coupled to the processor. The at least one memory is operable to store sales confirmation data associated with at least one customer transaction. The system also includes a sales data receiver for receiving first sales data from at least one customer. The sales confirmation data includes attribution information for determining a sales entity to receive attribution for the at least one customer transaction. The processor is operable to cause the sales data to be stored in the at least one memory.

According to another embodiment, a system for confirming customer transactions includes at least one processor and at least one memory electronically coupled to the processor. The at least one memory is operable to store sales data. The system further includes a confirmation platform operable to receive sales confirmation data from at least one customer contemporaneously with a transaction between the at least one customer and a sales associate. The confirmation platform is further operable to determine, based at least partially on the sales confirmation data, whether the transaction is attributable to the sales associate.

According to another embodiment, a method is provided for confirming at least one customer transaction between at least one customer and at least one sales associate. The method includes receiving, in a communication initiated by the at least one sales associate, first sales data from the at least one customer. The first sales data includes attribution information for determining whether the at least one sales associated is to be credited with the at least one transaction. The method also includes receiving second sales data from the at least one sales associate and comparing the first sales data to the second sales data to determine whether the at least one transaction is attributable to the at least one sales associate.

Various embodiments of the present invention may benefit from numerous advantages. It should be noted that one or more embodiments may benefit from some, none, or all of the advantages discussed below.

One advantage is that attribution for customer transactions, such as sales, may be more accurately determined as compared with prior methods. The system provides a confirmation process independent of input from a sales associate. The confirmation process includes collecting information directly from customer and comparing the information to additional confirmation information provided by the sales associate.

Another advantage is that the confirmation process is automated. This may be accomplished by having the customer interface with an automated voice prompt system and/or a voice recognition unit. The various automated components can collect the data from the customer and send the data to one or more processors to create an electronic record of a transaction confirmation.

Another advantage is that the associate-independent confirmation may be obtained and processed contemporaneously with a dialog between the customer and a sales associate.

Another advantage is that the transaction attribution (i.e., the determination that a particular transaction is attributable to a particular associate) may be accomplished in real-time, or near-real time. The determination may be accomplished, for example, contemporaneously with the dialog between the customer and the sales associate.

Other advantages will be readily apparent to one having ordinary skill in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates an example system for confirming whether a transaction involving a customer is attributable to a sales associate in accordance with an embodiment of the invention; and

FIG. 2 illustrates an example method for confirming whether a transaction involving a customer is attributable to a sales associate in accordance with an embodiment of the invention.

### DETAILED DESCRIPTION

Certain embodiments of the present invention are generally directed to providing systems and methods for routing calls. The call routing may be associated with, for example, routing calls to and/or from customers in a call center environment. The system may include a router, which can route calls based upon specified agent criteria. The router compares the specified criteria to agent qualifications to determine which agents are suited to handle the respective call. In one embodiment a criterion is a requirement that the agent have a license to sell the a product which is the subject of the call.

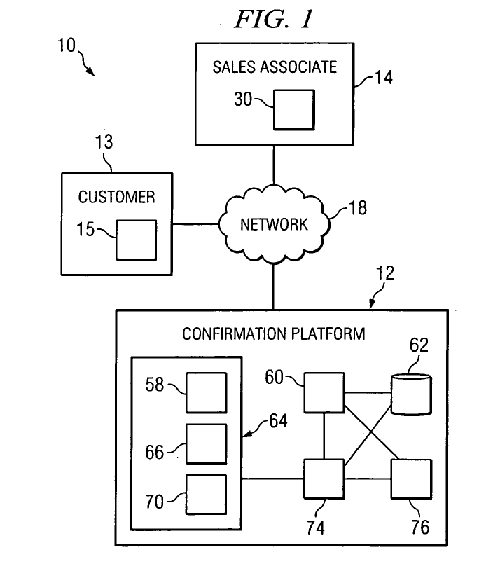

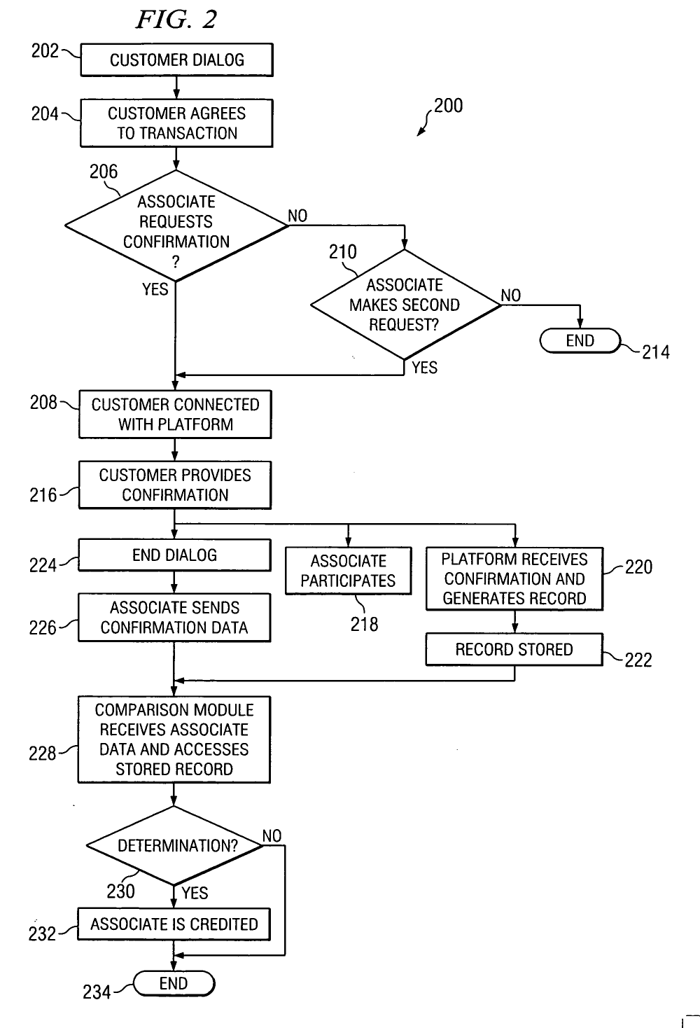

Example embodiments of the present invention and their advantages are best understood by referring now to FIGS. 1 and 2 of the drawings, in which like numerals refer to like parts.

FIG. 1 illustrates an example embodiment in which a call routing system 10 is provided for routing calls based at least partially on one or more qualifications of agents handling calls with customers. System 10 includes one or more callers 13, a communications network 18 and a call center 12. The call center 12 includes one or more agents 14 and a call routing platform 64. The call routing platform 64 includes at least one processor 60 and at least one memory 62. The call routing platform 64 also includes a call router 76.

Callers 13 may be, for example, customers or potential customers. However, callers 13 may be any appropriate individual, entity, or automated system. In the illustrated embodiment, caller 13 is an individual consumer, but the invention is not so limited. Callers 13 may be conducting any suitable transaction with one or more agents 14 including, but not limited to, the purchase of goods or services. Callers 13 may be engaging, for example, in transactions involving the purchase of services being promoted by the agents. In another example alternative, callers 13 may be contacting agents for support concerning products (e.g., computers systems or other goods, telecommunications services, accounts, policies, etc.), which are handled by the agents 14. In at least one embodiment, callers 13 are conducting transactions involving the purchase of insurance policies. In other example embodiments, however, callers 13 may be applying for credit card accounts or other accounts, purchasing real estate, purchasing medical services, receiving medical advice, receiving legal advice, asking for information about products, seeking support for problems with products or services, etc.

Each caller 13 may include an interface 15 for enabling the caller to communicate with agents 14 and/or call center 12 or any of its components. Callers 13 may include any suitable communication device (not expressly shown) such as a telephone, mobile phone, personal data assistant, or computer, for communicating with the various elements of system 10. Interface 15 may be a component of the communication device utilized by caller 13. In some embodiments, interface 15 is the communication device. Preferably, interface 15 allows caller 13 to engage in transactions and to transmit information (e.g., transaction criteria, sales information, identification information, etc.) to agents 14 and/or call center 12.

Agents 14 include any appropriate individuals, entities, or automated systems capable of interfacing with callers to conduct transactions. In the illustrated embodiment, agents 14 are individuals located at call center 12. Agents 14 can be located in any suitable place including being co-located with the call center 12. However, it should be understood that agents 14 may be remotely located.

The term “transaction” is intended to encompass any transaction with the caller 13. For example, the transaction may be a sale, or the customer's confirmation of, or commitment to make, a purchase. However, the invention is not limited to sales. Any exchange (e.g., currency or other financial consideration, or information) between a caller 13 and an agent 14 may qualify as a transaction.

Agent 14 may comprise a sales platform. For example, agent 14 may comprise one or more computers (not expressly shown). Preferably, each agent 14 includes an interface 30 for enabling an operator (e.g., the agent) to communicate with the other components of call center 12 and/or with callers 13. The interface may comprise a graphic user interface, for example. Any suitable interface may be used. Interface 30 may be used to conduct sales transactions and/or other customer transactions. Interface 30 may also be used to connect a caller 13 to platform 12 or its components. Interface 30 may also be used to transmit information between agents 14 and the other components of system 10.

Callers 13 and agents 14 may conduct transactions over any suitable communication link such as, for example, communications network 18. However, the transactions may be conducted over a communication link separate from communications network 18.

Communications network 18 may include one or more local area networks (LANs), metropolitan area networks (MANs), wide area networks (WANs), portions of the Internet, or any other appropriate wireline, optical, wireless, or other links, or any combination thereof. Communications network 18 may, where appropriate, include one or more private networks used exclusively for communication between any of callers 13, agents 14, and call center 12.

Call center 12 may include one or more call routing platforms 64, one or more processors 60, one or more memories 62, and one or more call routers 76, and one or more agents 14. The illustrated configuration of the various components of call center 12 is provided for example purposes only. It should be understood that any suitable configuration may be used. Various components may be integral or discreet and remote or centralized as desired. The grouping of components as subcomponents (e.g., call router 76 and processor 60 as subcomponents of call routing platform 64) is shown for example purposes only. It should be understood that various components may or may not include the subcomponents illustrated in FIG. 1. It should be further understood that various components illustrated as part of call center 12 may exist, in certain embodiments, remote from call center 12. Moreover, the communication links shown in FIG. 1 may be modified as desired. The components of call center 12 may be located at one or more sites and may be coupled to each other using one or more links, each of which may include, for example, some or all of a computer bus, local area networks (LANs), metropolitan area networks (MANs), wide area networks (WANs), portions of the Internet, a public switched telephone network (PSTN), any other appropriate wireline, optical, wireless, or other suitable communication link, or any combination of the preceding.
}}}}}}}}}}}}

Sales data receiver 64 may include one or more data reception modules 74, one or more operator terminals 58, and one or more voice recognition units 66

Sales data receiver 64 is preferably operable to receive sales data from either or both of customer 13 and sales associate 14. Sales data may include any information associated with a customer transaction. In one embodiment, sales data received from customer 13 includes, for example, customer identification data, sales associate identification data, transaction data, and sales confirmation data. Customer identification data may include any information identifying a particular customer, such as name, address, phone number, customer identification number, account number, etc. Sales associate identification data may include any information to identify the particular sales associate handling a transaction with the customer. Such information may include, for example, an associate identification number, call center identification number, associate name, etc. Transaction data may include, for example, any information to identify a particular transaction, such as product identification number, product description, call identification number, purchase amount, transaction date and time, transaction identification number, invoice number, etc. Sales confirmation data may include any information indicative of a customer confirming that a transaction has been, or will be, made. Such information may include, for example, a textual, numeric, or oral indication of “yes” or “no.” Data received from sales associate 14 may include, for example, the same types of information received from customer 13 as described above. In certain embodiments some of the sales data is received from customer 13 and some is received from sales associate 14. In at least one embodiment, the customer 13 provides sales confirmation data to sales data receiver 64.

Depending on the embodiment, sales data may be received by any one, or any combination of, voice recognition unit 66, operator terminal 58, and/or data reception module 70. In at least one embodiment, sales data is received by voice recognition unit 66 from customer 13. Voice recognition unit 66 may be any suitable component or subsystem capable of receiving verbal information and translating that information into electronic data. In at least one embodiment, the data is received by data reception module 70. Module 70 may be a software module executable by one or more processors (e.g., processor 60).

In at least one embodiment, the data is received by an operator terminal 58. Operator terminal 58 may provide an operator, manager, other employee, or other individual associated with platform 12 with the ability to receive data from customer 13 and/or sales associate 14. Operator terminal 58 may also be in communication with, and transmit and receive data to and from the other components of platform 12. Operator terminal 58 may include a computer system. As used in this document, the term “computer” refers to any suitable device operable to accept input, process the input according to predefined rules, and produce output, for example, a personal computer, workstation, network computer, wireless data port, wireless telephone, personal digital assistant, one or more processors within these or other devices, or any other suitable processing device. Although shown as a separate component, operator terminal 58 may include or be partially or completely integrated with the other components of platform 12.

Processor 60 may process data associated with customer transactions, execute any of the various software modules described herein, and cause data to be stored. The operation of processor 60 may include executing software or coded instructions that may in particular embodiments be associated with the one or more function modules. Processor 60 may be any suitable processor for processing data. Memory 62 may be coupled to processor 60 and may include one or more suitable memory devices, such as one or more random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), microcontrollers, or microprocessors.

A sales data comparison module 74 may provide particular functionality associated with accessing sales data from any available source and comparing certain sales data with other sales data. Preferably, sales data comparison module can access data stored in memory 62, and may receive data from any of the subcomponents of data receiver 64 or directly from customer 13 and/or sales associate 14.

A transaction module 76 may be generally operable to manage transactions engaged in by customer 13. For example, transaction module may be operable to receive information concerning a transaction from customer 13 and/or sales associate 14. Transaction information can include any of the information already described. For example, transaction information may include any information related to any transaction. Transactions may include the sale or purchase of goods or service. Transaction information may include, without limitation, merchant identification information, transaction amount, purchased item information, date, time, purchaser identity information, sales tax information, location information, customer and card codes, account numbers, etc. In certain embodiments, transaction module 76 generates sales data. The generation of sales data by transaction module 76 may be based on information received from customer 13 and/or sales associate 14.

In at least one embodiment, a customer 13 and a sales associate 14 engage in a dialog concerning a transaction over communication network 18. At some point in the dialog, sales associate 14 indicates to customer 13 that in order to complete the transaction, customer 13 must provide transaction confirmation data to platform 12. The request by sales associate 14 may simply include a request that customer 13 provide a positive indication to sales data receiver 64. Customer 13 may provide the indication in response to automated prompts, for example, and the positive indication (e.g., a verbal “yes”) may be received, for example, by voice recognition unit 66. Processor 60 causes the sales confirmation data to be stored in memory 62.

Additional sales data is generated by transaction module 76. Such data includes, for example, transaction identification, customer identification and sales associate identification. A transaction record including the transaction identification, sales associate identification, customer identification, and the confirmation data is generated, for example, by transaction module 76 and stored in memory 62.

Sales data receiver 64 receives additional information from sales associate 14. Such information may include, for example, sales associate identification, transaction identification, and the sales associate's indication of a sales confirmation for the particular transaction. Sales data comparison module 74 accesses the relevant transaction record from memory 62 and compares the confirmation data provided by sales associate 14 with the stored confirmation data. If the relevant transaction record indicates a positive confirmation, the comparison module is operable to create attribution information, which indicates that the transaction is attributable to the particular sales associate 14. Thus, any credit due to the sales associate (e.g., a sales commission) may be provided to the sales associate based on the assessment that the transaction was confirmed independent of the sales associate's input.

In certain embodiments, sales data is received, processed and stored in batches. The batch processing may be accomplished at predetermined times or intervals. At other predetermined times a batch file including a plurality of transaction records may be compared with a plurality of sales confirmation indications provided, for example, by sales associate 14.

In certain embodiments, during a dialog with a customer, the sales associate may initiate the establishment of a communication link between the customer and the confirmation platform to enable the customer to provide sales data, such as confirmation data, to the confirmation platform or its components. The link may be provided as a direct connection between the customer and the platform with or without the participation of the sales associate. In certain embodiments, the sales associate monitors the communication between the customer and the platform. In other embodiments the sales associate is not involved in the communication. In certain embodiments, the communication link is established, at least in part, by the sales associate speed dialing a number associated with the platform or one of its data reception components on behalf of the customer and then handing off the resulting connection to the customer. In at least one embodiment, the established communication link comprises a conferencing link in which the customer, sales associate, and platform (or one or more of the platform components) are all participants.

FIG. 2 illustrates an example method 200 for confirming whether a transaction involving a customer is attributable to a sales associate. At step 202, a sales associate starts a dialog with a customer. The dialog may concern any potential customer transaction such as, for example, a sale of a product (goods or services) to the customer. At step 204, during the dialog, the customer indicates that he or she wishes to engage in the transaction. The transaction may be, for example, the purchase of the product. However, the transaction may be any action by the customer, such as agreeing to provide information, participating in a poll, agreeing to accept information via email, etc.

At step 206, the sales associate requests the customer to provide confirmation data. The confirmation data can be any data indicative of the customer's willingness to engage in the transaction. For example, the confirmation data may be a positive response to a query. The data may be a numeric, textual or oral indication of such a positive response. The confirmation data may also include other information associating the positive indication with the particular transaction and the particular sales associate. Such information may include any of the information already described herein such as, for example, transaction identification data (transaction number or identifier, product description, purchase price, transaction date and time, etc.), sales associate identification data (name, identification number or other identifier, work location identifier such as call center identification, etc.), and customer identification data (customer name, address, telephone number, social security number, account number, customer login/password, etc.).

At step 208, if the customer agrees to provide the confirmation data, the customer is connected with a confirmation platform. In at least one embodiment, the customer is connected with a sales data receiver. The customer provides the confirmation data to the sales data receiver. The connection between the customer and the confirmation platform may be established by any suitable means and may comprise any suitable communications link. The connection may be initiated by the sales associate by any acceptable method. For example, the sales associate may simply activate a trigger, which initiates that communications link. The sales associate may dial (manually, or by speed dialing, or voice activated dialing) a number associated with the confirmation platform. The link may exclude or include the sales associate. For example, it may be desirable to allow the customer to interface with the confirmation platform without sales associate participating. In other embodiments, the sales associate can monitor the exchange between the customer and the confirmation platform, but cannot actively participate in the exchange. In still other embodiments, the communications link is a conferencing link between the customer, the sales associate and the confirmation platform. In these embodiments, the sales associate can participate in the exchange by, for example, assisting the customer in the confirmation process and/or providing sales data information relevant to the transaction. It is preferable that the confirmation data (i.e., the positive indication by the customer) comes from the customer.

If, at step 206, the customer does not agree to provide confirmation data, then at step 210, the sales associate explains the necessity for the provision of confirmation data and makes a second request to the customer. If the customer then agrees, the customer is connected with the platform as described above in connection with step 208. If the customer still disagrees, then at step 214 the call is ended. In this case, the transaction may still be completed without the confirmation data being provided. Alternatively, the dialog may be discontinued without allowing the transaction to proceed.

At step 216, the confirmation provides the confirmation data. The data may be received, for example, by a sales data receiver associated with the confirmation platform. The sales data receiver may comprise any suitable equipment, personal, or process for receiving data, as described elsewhere herein. In at least one embodiment, the sales data receiver comprises a voice recognition unit for interacting with the customer. The customer may respond to prompts and verbally answer questions regarding the transaction. The customer should at least be asked to provide confirmation data, which confirms that the customer has engaged in, or will engage in, a particular transaction. The confirmation platform may also receive other transaction information. This information may be received from the customer and the sales associate. This information may also be generated, by a transaction module for example, and sent to the sales data receiver.

At step 220, the confirmation data is captured by the confirmation platform (e.g., by the sales data receiver, the transaction module, or some other component). A record may be created, which includes the confirmation data. The record may also include other associated transaction data. At step 222, the confirmation data is stored. At step 218, if desired and if the appropriate communications link has been established, the sales associate may monitor and/or participate in the exchange between the customer and the confirmation platform and may also provide additional information to the confirmation platform. At step 224, the dialog between the customer and the sales associate is ended.

It should be understood that the receipt of information by the confirmation platform may encompass multiple transactions with multiple customers and sales associates. The creation of records and the receipt, generation, processing, and storage of transaction data (including confirmation data) may be accomplished according to batch processing techniques and at predetermined times or time intervals.

At step 226, the sales associate sends data indicative of the associate's record of sales confirmations. The data may be sent to the confirmation platform or to some other platform, system, component or individual. In at least one embodiment, the associate data is sent to a sales data comparison module embodied in software, which may or may not be integral with the confirmation platform.

At step 228, the sales associate confirmation data is compared to the previously-collected (and possibly stored) confirmation data collected from the customer. The comparison is made to determine whether the confirmation data and or other data matches, or is otherwise indicative of, a result in which the sales associate should receive attribution for the transaction. In certain embodiments, the comparison is made by the sales data comparison module. The module receives the confirmation information from the sales associate and accesses the stored transaction records (which include the customer's confirmation data). The module then compares the information to determine whether the transaction is attributable to the sales associate. At step 230, a determination (positive or negative) is made regarding attribution. If a positive determination is made, the sales associate is credited with the transaction at step 232. If a negative determination is made, the sales associate is not credited and the process ends at step 234.

Modifications, additions, or omissions may be made to the method without departing from the scope of the invention. Additionally, steps may be performed in any suitable order without departing from the scope of the invention.

Although an embodiment of the invention and its advantages are described in detail, a person skilled in the art could make various alterations, additions, and omissions without departing from the spirit and scope of the present invention as defined by the appended claims.

1. A system for confirming customer transactions, comprising:
at least one processor;
at least one memory electronically coupled to the processor, the at least one memory operable to store sales confirmation data associated with at least one customer transaction;
a sales data receiver for receiving first sales data from at least one customer, the sales confirmation data comprising attribution information for determining a sales entity to receive attribution for the at least one customer transaction, the processor operable to cause the sales data to be stored in the at least one memory.

2. The system of claim 1, further comprising a communication network operable to provide a communication link between the at least one customer and the sales data receiver, the first sales data received over the communication link.

3. The system of claim 2, wherein the communication link comprises a conferencing link between the at least one customer, the sales associate, and the sales data receiver, the first sales data received over the communication link.

4. The system of claim 1, further comprising a sales data comparison module operable to receive second sales data corresponding to at least one customer transaction; and further operable to compare the second sales data to the first sales data to confirm the attribution.

5. The system of claim 1, wherein the sales data receiver comprises an operator for receiving the first sales data from the at least one customer.

6. The system of claim 1, wherein the sales data receiver comprises a data reception module operable to receive the first sales data from the at least one customer.

7. The system of claim 1, wherein the sales data receiver comprises a voice recognition unit operable to receive the first sales data from the at least one customer.

8. The system of claim 1, further comprising a sales confirmation platform, the sales confirmation platform comprising the at least one processor, the at least one memory and the sales data receiver.

9. The system of claim 1, further comprising a sales associate interface in communication with the sales data receiver and operable to transmit the second sales data for comparison to the first sales data.

10. The system of claim 1, further comprising a sales associate interface in communication with the sales data receiver and operable to establish a communication link between the at least one customer and the sales data receiver.

11. A system for confirming customer transactions, comprising:
at least one processor;
at least one memory electronically coupled to the processor, the at least one memory operable to store sales data;
a confirmation platform operable to receive sales confirmation data from at least one customer contemporaneously with a transaction between the at least one customer and a sales associate, and further operable to determine, based at least partially on the sales confirmation data, whether the transaction is attributable to the sales associate.

12. The system of claim 11, wherein the confirmation platform is further operable to store the sales confirmation data in the at least one memory.

13. The system of claim 11, the confirmation platform comprising a data receiver for receiving the sales confirmation data.

14. The system of claim 13, wherein the data receiver comprises an operator.

15. The system of claim 13, wherein the data receiver comprises a data reception module.

16. The system of claim 13, wherein the data receiver comprises a voice recognition unit.

17. The system of claim 11 further comprising a sales associate interface operable to establish a communication link between the at least one customer and the confirmation platform, the sales confirmation data being received over the communication link.

18. The system of claim 17, wherein the communication link is established by the sales associate speed dialing the confirmation platform.

19. The system of claim 17, wherein the communication link comprises a conferencing link between the at least one customer, the sales associate, and the confirmation platform.

20. The system of claim 11, further comprising a sales data comparison module for comparing the confirmation data to data received from the sales associate corresponding to the transaction.

21. A method for confirming at least one customer transaction between at least one customer and at least one sales associate, the method comprising:
receiving, in a communication initiated by the at least one sales associate, first sales data from the at least one customer, the first sales data comprising attribution information for determining whether the at least one sales associated is to be credited with the at least one transaction;
receiving second sales data from the at least one sales associate; and
comparing the first sales data to the second sales data to determine whether the at least one transaction is attributable to the at least one sales associate.

22. The method of claim 21, further comprising storing the first sales data in at least one memory.

23. The method of claim 21, further comprising receiving the first sales data over a communication link initiated by the at least one sales associate.

24. The method of claim 21, wherein the first sales data is received by an operator.

25. The method of claim 21, wherein the first sales data is received by a voice recognition unit.

26. The method of claim 21, wherein the first sales data is received by a data reception software module.

27. The method of claim 21, wherein the first sales data comprises a call record.

28. The method of claim 21, wherein the attribution information comprises a call record.

29. The method of claim 21, further comprising establishing a communication link between the at least one customer and a data receiver that receives the first sales data.

30. The method of claim 29, wherein the communication link comprises a conferencing link between the at least one customer, the at least one sales associate and the data receiver.

31. The method of claim 21 further comprising:
periodically, at one or more predetermined times, receiving a batch of first sales data;
storing the batch of first sales data; and
comparing the batch of first sales data to a batch of second sales data received from a plurality of sales associates.
